(19) United States
(12) Patent Application Publication
(10) Pub. No.: US 2004/0061815 A1
(43) Pub. Date: Apr. 1, 2004

(54) Arrangement for generating positive and negative images in digital projection

(75) Inventor: Arne Troellsch, Grossschwabhausen (DE)

Correspondence Address: Gerald H. Kiel, Esq., REED SMITH LLP, 599 Lexington Avenue, New York, NY, 10022-7650, US

(73) Assignee: CARL ZEISS JENA GmbH

(21) Appl. No.: 10/676,339

(22) Filed: Sep. 30, 2003

(30) Foreign Application Priority Data
Sep. 30, 2002 (DE) 102 46 484.7

(51) Int. Cl. G02F 1/1335

(52) U.S. Cl. 349/96

(57) ABSTRACT

In order to provide an arrangement for the simultaneous generation of a positive image and a negative image in digital projection, comprising a light source, polarizing optics for delivering a preferably linearly polarized light flow, at least one polarizing beam splitter, and an LCD panel, by which a positive image and a negative image are generated simultaneously in an economical, reliable and highly accurate manner using simple technical apparatus, it is proposed that two polarizing beam splitters are provided in the beam path between a light source with polarizing optics arranged following the light source and a reflecting LCD panel and a Faraday rotator is arranged between the polarizing beam splitters.

### CROSS-REFERENCE TO RELATED APPLICATION

This application claims priority of German Application No. 102 46 484, filed Sep. 30, 2003, the complete disclosure of which is hereby incorporated by reference.

### BACKGROUND OF THE INVENTION

a) Field of the Invention

The invention is directed to an arrangement for simultaneous generation of a positive image and a negative image in digital projection, comprising a light source, polarizing optics for delivering a preferably linearly polarized light flow, at least one polarizing beam splitter, and an LCD panel for modulating the light flow.

b) Description of the Related Art

It is known from the prior art that digital projectors based on preferably reflecting LCD panels use only a portion of the available light to project a positive image. Due to the necessary modulation, a large portion of the emitted light does not reach the imaging beam path but, rather, is reflected back into the light source.

DE 196 07 510 A1 discloses an LCD projector for projecting a color image on a screen and a method for projection in which substantially all of the light from the light source is projected on a screen. The LCD projector is a white light source for delivering a randomly polarized light flow and comprises a plurality of LCD fields for modulating the light flowing through it, as well as three polarizing beam splitters for dividing the light flow into three light flows with different wavelength regions, and each of the three light flows has the same polarization. Further, four reflection devices are provided for the different reflection spectra and three combination devices are provided for combining the split light flows.

### OBJECT AND SUMMARY OF THE INVENTION

Proceeding from the prior art mentioned above, it is the primary object of the invention to provide an arrangement for the simultaneous generation of a positive image and a negative image in digital projection by which a positive image and a negative image are generated simultaneously in an economical, dependable and highly accurate manner using simple technical apparatus and using all of the available light.

In accordance with the invention, an arrangement is provided in which two polarizing beam splitters and a Faraday rotator arranged between the polarizing beam splitters are provided in the beam path between a light source with polarizing optics arranged following the light source and a reflecting LCD panel arranged in front of the reflecting LCD panel.

In an advantageous embodiment form, a rotation of the polarization plane of the incident light by 45° is carried out by means of the Faraday rotator when the light passes through the latter only once.

Further, it is advantageous that the first polarizing beam splitter which is arranged following the polarizing optics is provided for projecting a negative image.

It is preferably further provided that the second polarizing beam splitter arranged following the Faraday rotator and in front of the reflecting LCD panel is provided for projecting a positive image.

An advantageous further development consists in that when all of the pixels of the reflecting LCD panel are switched on and the polarization plane of the polarized light is accordingly rotated by 90° by means of the polarizing beam splitter, the light which is reflected out of the beam path is provided for projecting the positive image.

In another preferred embodiment form, when all of the pixels of the reflecting LCD panel are switched off, after the polarized light passes through the second polarizing beam splitter and passes a second time through the Faraday rotator and after the polarization plane is rotated by 90° in this way relative to that of the light traveling toward the first polarizing beam splitter by means of the first polarizing beam splitter, the light reflected out of the beam path is provided for projecting the negative image.

When digital projectors are used, particularly with reflecting LCD panels, the invention makes it possible to use all of the available light for projection, i.e., also the portion of light which is reflected back into the light source rather than in the imaging beam path due to the necessary modulation, so that there is an effective use of the light flow as well as a good optical positive image and negative image at the same time without additional costs and technical expenditure for the optical system in its entirety.

The invention will be described more fully in the following with reference to the schematic drawing.

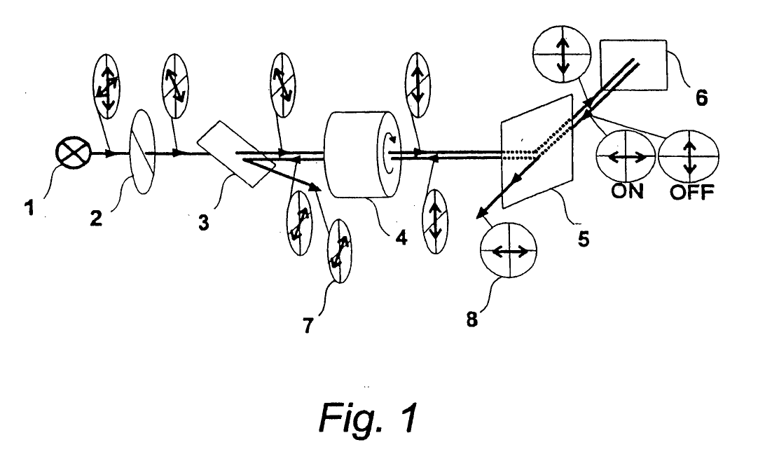

FIG. 1 shows a schematic view of an optical beam path, according to the invention, in digital projection.

FIG. 1 shows the minimal optical beam path of a digital projection system without objectives with the individual optical components.

The light that is emitted by a light source 1 and linearly polarized by polarizing optics 2 passes through a first polarizing beam splitter 3 to a Faraday rotator 4 which rotates the polarization plane by 45° and through a second polarizing beam splitter 5 to a reflecting LCD panel 6 that reflects the light back. When all of the pixels of the reflecting LCD panel 6 are switched on, the polarization direction is rotated by 90° and this light is then reflected out of the optical beam path through the second polarizing beam splitter 5 and is used for projecting a positive image 8. When all of the pixels of the LCD panel 6 are switched off, the polarizing direction of the light is not influenced, so that this light passes freely through the second polarizing beam splitter 5 and makes a second passage through the Faraday rotator 4 and the polarization direction is rotated again by 45°, so that the polarization plane is now rotated by 90° relative to that of the light on its way to the first polarizing beam splitter 2. This light is then reflected out of the beam path by the first polarizing beam splitter 2 and is used for projecting a negative image 7.

The invention is not limited to the embodiment example, but can be varied in a variety of ways within the framework of the disclosure through the use of different optical beam splitters and LCD panels in constructing the digital projection system.

All novel individual features and combined features disclosed in the specification and/or the drawing are considered substantial to the invention.

While the foregoing description and drawings represent the present invention, it will be obvious to those skilled in the art that various changes may be made therein without departing from the true spirit and scope of the present invention.

What is claimed is:

1. An arrangement for simultaneous generation of a positive image and a negative image in digital projection, comprising:
a light source;
polarizing optics for delivering a linearly polarized light flow;
at least one polarizing beam splitter; and
an LCD panel for modulating the light flow;
said arrangement further comprising:
polarization optics and a reflecting LCD panel being arranged following said light source and in the beam path; and
two polarizing beam splitters having a Faraday rotator arranged therebetween being further arranged in front of the reflecting LCD panel.

2. The arrangement according to claim 1, wherein a rotation of the polarization plane of the incident light by 45° is carried out by the Faraday rotator with the light passing through only once.

3. The arrangement according to claim 1, wherein the first polarizing beam splitter which is arranged following the polarizing optics is provided for projecting a negative image.

4. The arrangement according to claim 1, wherein the second polarizing beam splitter arranged following the Faraday rotator and in front of the reflecting LCD panel is provided for projecting a positive image.

5. The arrangement according to claim 1, wherein when all of the pixels of the reflecting LCD panel are switched on and the polarization plane of the polarized light is rotated by 90° in this way by the polarizing beam splitter, the light which is reflected out of the beam path is provided for projecting the positive image.

6. The arrangement according to claim 1, wherein, when all of the pixels of the reflecting LCD panel are switched off, after the polarized light passes through the polarizing beam splitter and passes a second time through the Faraday rotator and after the polarization plane is rotated by 90° in this way relative to that of the light traveling toward the polarizing beam splitter by the polarizing beam splitter, the light reflected out of the beam path is provided for projecting the negative image.
